(19) United States
(12) Patent Application Publication
(10) Pub. No.: US 2013/0339801 A1
(43) Pub. Date: Dec. 19, 2013

(54) SYSTEM AND METHOD FOR LOG AND TRACE DIAGNOSTICS AND ANALYTICS

(71) Applicant: Satish Ramaiah, West Chester, PA (US)

(72) Inventor: Satish Ramaiah, West Chester, PA (US)

(73) Assignee: SAP AG, WALLDORF (DE)

(21) Appl. No.: 13/523,129

(22) Filed: Jun. 14, 2012

(51) Int. Cl. G06F 11/16

(52) U.S. Cl. 714/45; 714/E11.055

(57) ABSTRACT

A system maintains a plurality of system logs and a plurality of system traces. The system extracts data from the plurality of system logs and system traces, and combines the extracted data into a centralized history of system logs and system traces. The system examines the centralized history of system logs and system traces to identify issues and problems in the system, and further identifies the issues and problems that require attention. The system also identifies a person or a group that is responsible for the identified issues and problems, and transmits a message to the identified person or group informing the identified person or group of the identified issues and problems.

### TECHNICAL FIELD

The present disclosure relates to a system and method for log and trace diagnostics and analytics in a computer system, and in an embodiment, but not by way of limitation, a system and method for log and trace diagnostics and analytics in an entire end to end information technology landscape.

### BACKGROUND

In most computing systems, log and trace files are the location where system problems and other product related monitoring information are captured via coding in the software product itself This monitoring mechanism has not changed in many years, and even today administrators and support staff approach the solving of system and product problems in much the same rudimentary way by just accessing the log and trace files, via a log viewer or manual examination, to try to determine the issues and problems related to the system and/or product.

### BRIEF DESCRIPTION OF THE DRAWINGS

FIG. 1 is a block diagram illustrating an information technology (IT) landscape.

FIG. 2 is a block diagram illustrating features and functions of a log and trace diagnostic and analytics system.

FIGS. 3A, 3B, and 3C are a flowchart-like diagram illustrating features and process steps of an example embodiment of a system and method for log and trace diagnostics and analytics.

FIG. 4 is a block diagram of an example embodiment of a computer system upon which one or more of the embodiments disclosed herein can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Currently, there are no systems that provide a single and centralized mechanism or solution to gather all relevant log and trace files for end to end business applications or end to end information technology (IT) scenarios. This is particularly an issue when such an IT landscape is covered by many different IT vendors, since each IT vendor will have its own log and trace file system and structures. In response to this lack of a centralized mechanism, an embodiment leverages existing system, log, and trace infrastructures and frameworks. This leveraging fits well into an ALM (Application LifeCycle Management) strategy of a product. This embodiment is a generic product idea that can be extended across an IT landscape and its many different IT vendors, and this provides a real time picture of the overall health of a system and aids in troubleshooting problems from an end to end perspective. Simply put, in an embodiment, there is one centralized place for monitoring and troubleshooting an end to end IT scenario or other IT environment.

In a more specific embodiment, system and program application logs and traces are enhanced to provide both proactive and reactive ways of monitoring and troubleshooting issues. This new intelligence from logs and traces can be derived with the help of business intelligence tools and workflow-based products that can effectively deal with issues proactively and reactively. Such tools can extract and harmonize logs and traces of different IT vendors and store this information into a central log system in a uniform format.

The vast majority of logs and traces follow a generic format of organizing and storing log data that are written into files. The generic format includes log messages in rows (lines) and columns that are separated by column separators (such as a space, a “#”, or any other character) and data that is stored in the rows. Log and trace information is recorded in these logs and traces based on settings of log and trace programs. These files can be converted to a table format (or database format) and fed into a business intelligence (BI) product (an example would be SAP's Business Intelligence and/or SAP Business Objects products). Logs and traces are meant to be end to end (that is, from a client (such as a browser) to a network, from the network to a database, from the database to an operating system, form the operating system to an application server, and finally from the application server to an application), thereby basically creating an N-tier IT landscape.

As noted, these logs and traces can be input into a business intelligence (BI) product at regular intervals, thereby generating a history of logs and traces (e.g., over the last few years). The BI features and functionalities can then be used to analyze the data and issues recorded in the logs and traces. This analysis gives an idea of the issues that users are experiencing, and the analysis can allow a system administrator to respond to such issues, and plan to prevent or avoid such issues in the future. Moreover, this analysis can create intelligence by co-relating logs and traces. This co-relating results in the expedient acquisition of useful information and an effective solving of issues in the IT landscape. For example, the co-relating can correlate the timestamps of the various system and log messages, which allows the correlation of an incident or event across the various logs and traces. This then permits system personnel to troubleshoot cross-system or cross component issues in a central place. This is especially beneficial in global IT landscape scenarios wherein global companies have IT centers in multiple locations in multiple time zones over the entire globe. In such global scenarios, the centralized logs and traces and the BI system create intelligence by providing insight into the state of the global IT landscape.

The BI Data (of all logs and traces) can be single source for an entire IT diagnostics. This can help in analyzing cross system and cross component issues by efficiently correlating, sorting, searching, and viewing (with the help of BI reports and in-memory features and technologies). The search capability of a BI tool can save much time by helping troubleshoot issues much more quickly, which leads to a quicker resolution of the issues. A business intelligence tool reporting feature can create reports from IT logs and traces. These reports provide information about the health and behavior of the IT landscape (such as a simple view of an increase in errors reported in the central log may mean more issues and/or problems in the IT landscape). This IT diagnostics BI system can help in both pro-active and reactive monitoring and problem analysis in the IT landscape. IT Support and/or administrative staff can benefit greatly with such a centralized system (IT diagnostics) and this can also help IT organizations to reduce the total cost of ownership (TCO). By reducing the total time expended in problem analysis and monitoring in the IT landscape, this reduces the staff required to maintain the IT landscape.

A system administrator can deal with the issues found in log and trace messages using several options. In a first option, a system administrator can use a workflow based triggering (or alert) mechanism. In this option, action items are defined if a particular log message (with a code or unique identifier) is recorded. For example, a server may have crashed, and this requires an immediate restart of the server. This event is recorded in the log file and event-based handling can be defined at the log service level in the application server where the product is residing. In a second option, reports can be created for the issues, remedies can be defined for the issues, and these remedies can be distributed to support staff and/or administrators. Additionally, auditing and security related information is reported using BI reports in this second option. In a third option, all related logs and traces are defined and collected, and intelligence is created from these files and correlated to obtain useful information quickly and effectively to solve issues. Intelligence can be extracted out of these logs and traces, and an enhanced feature (or a separate tool) can be a first effective tool in troubleshooting and/or monitoring product issues. This can be either a separate tool or a new feature in an ALM product. This can give a holistic view of a system via intelligence gathering of all log and trace files for the purpose of actively monitoring and solving any support problems in a much faster and efficient way.

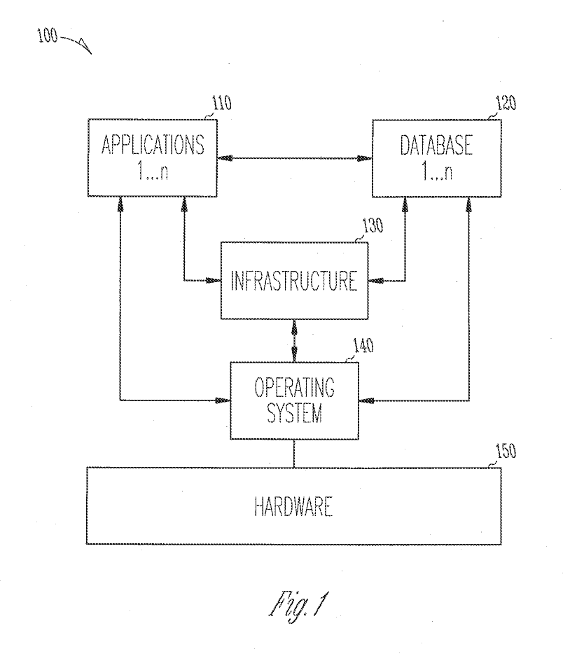

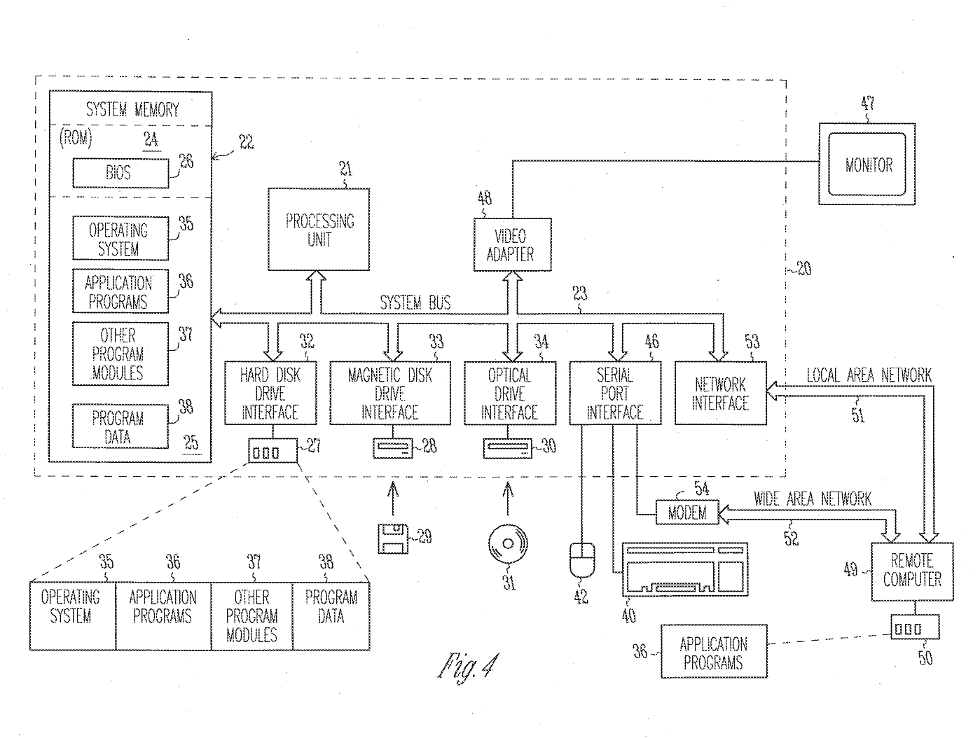

A typical information technology (IT) landscape 100 is illustrated in FIG. 1. Such a landscape 100 can include a plurality of applications 110 and a plurality of databases 120. These applications 110 execute on an infrastructure 130, which is on top of an operating system 140, which executes on hardware 150. More specific details of the hardware 150 can be found in FIG. 4, which is discussed in detail below.

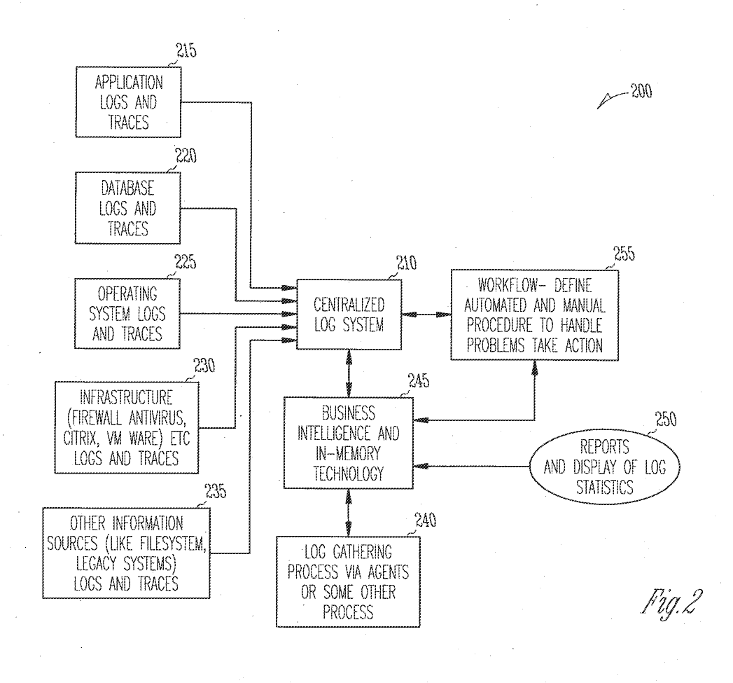

FIG. 2 illustrates features of a log and trace diagnostics and analytics system 200. The log and trace system 200 includes a centralized log system 210. The centralized log system 210 receives input from several entities, including application logs and traces 215, database logs and traces 220, operating system logs and traces 225, infrastructure (e.g., firewall, antivirus, Citrix®, VMware®, etc.) logs and traces 230, and other information source (FileSystem, legacy systems, etc.) logs and traces 235. The centralized log system 210 receives this input from a log gathering process via agents or some other process at 240. Business intelligence tools and in-memory technology 245 work on the centralized log to produce reports and display log statistics at 250. Workflow module 255 uses the centralized log 210 and the business intelligence module 245 to define automated and manual procedures to handle problems and take action to solve these problems.

The log and trace system 200 of FIG. 2 includes several features and functionalities. The log gathering process 240 implements a cleaning up of the formats of the different logs 215-235. Additionally, the log gathering process 240 can put the logs and traces into a common format, which then permits a side by side analysis of the logs and traces from the difference sources 215-235. As previously noted, a BI tool can be used on the extracted and cleansed log and trace data at 245 to extract intelligence from the plurality of logs and traces 215-235. The BI tool can key on error codes in the logs and traces and execute predefined actions based on those error codes. Block 245 further indicates that extracted and cleansed logs and traces can be placed in an in-memory technology. In-memory technology permits much faster processing and analysis. Normally, the data maintained in in-memory is limited to a few days worth of data, so as to conserve storage space. In most circumstances, log and trace data is not normally needed on an immediate basis after a few days. A root cause analysis can also be performed on the extracted and cleansed data, which aids in faster and proactive monitoring,

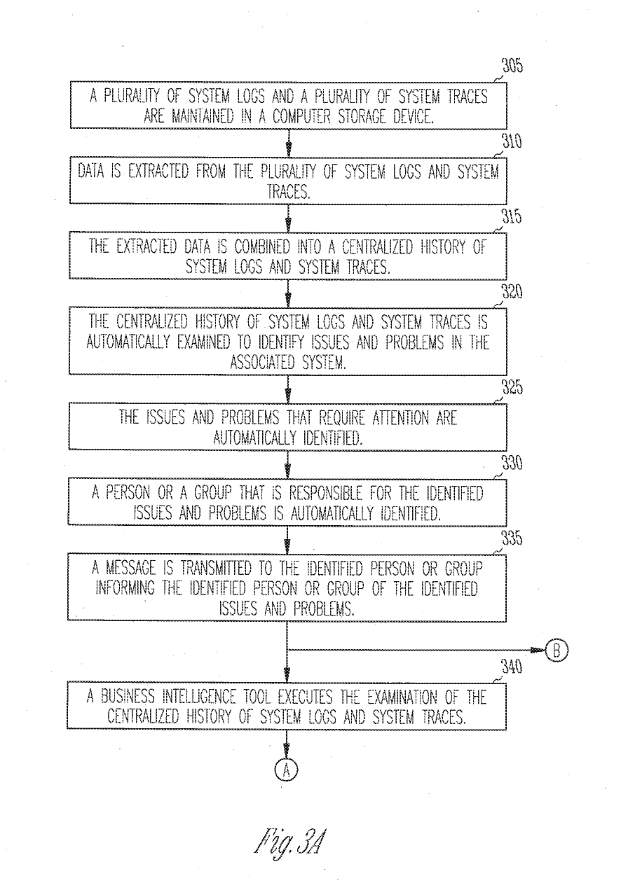

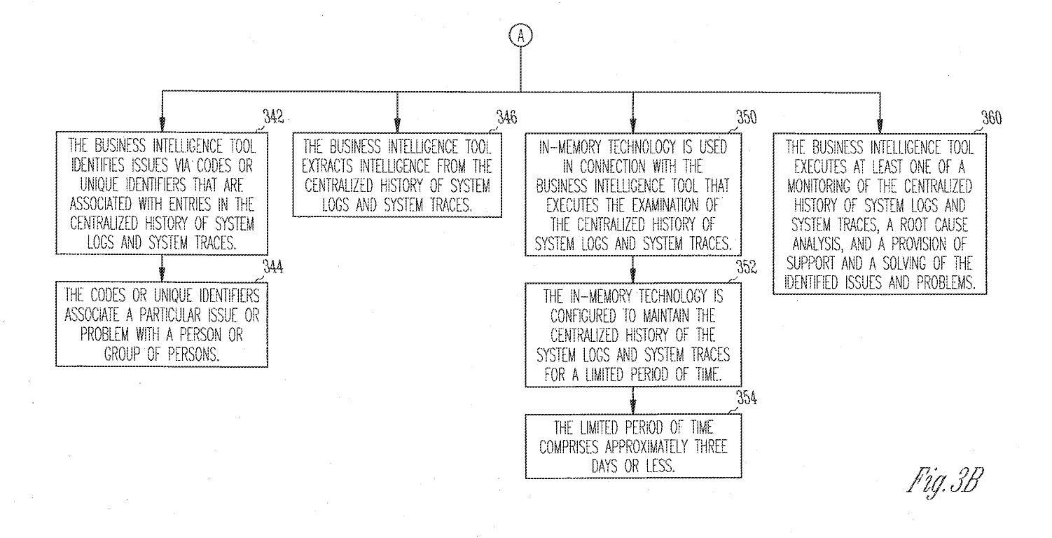

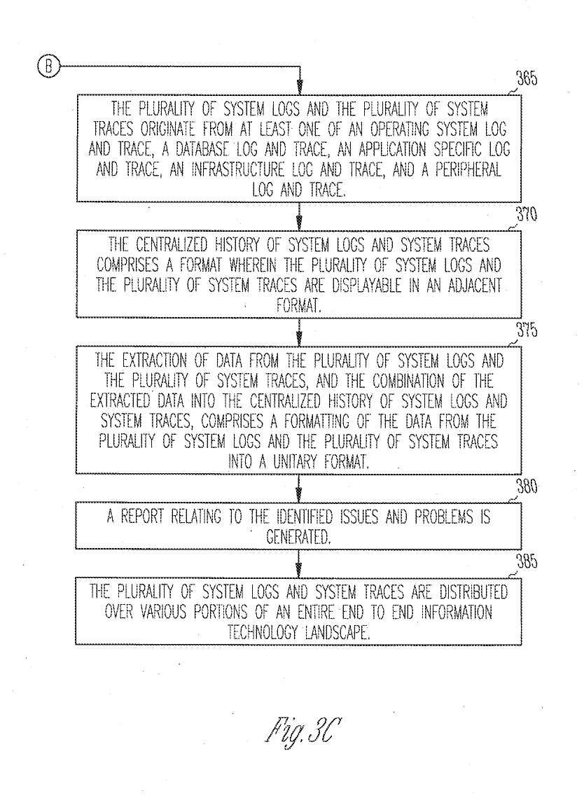

FIGS. 3A, 3B, and 3C are a flowchart-like block diagram of features and steps in an example process 300 for extracting and cleansing data from a plurality of log and trace files. FIGS. 3A, 3B, and 3C include a number of process blocks 305-385. Though arranged serially in the example of FIGS. 3A, 3B, and 3C, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 3A, 3B, and 3C, at 305, a plurality of system logs and a plurality of system traces are maintained in a computer storage device. At 310, data is extracted from the plurality of system logs and system traces. At 315, the extracted data is combined into centralized history of system logs and system traces. At 320, the centralized history of system logs and system traces is automatically examined to identify issues and problems in the associated system. At 325, the issues and problems that require attention are automatically identified. At 330, a person or a group that is responsible for the identified issues and problems is automatically identified. And at 335, a message is transmitted to the identified person or group informing the identified person or group of the identified issues and problems.

At 340, a business intelligence tool executes the examination of the centralized history of system logs and system traces. At 342, the business intelligence tool identifies issues via codes or unique identifiers that are associated with entries in the centralized history of system logs and system traces. Another example is the use of a timestamp across the system logs and messages to correlate an incident or event across the entire IT landscape. This correlation can create intelligence by assimilating this data from the entire IT landscape, which aids in troubleshooting cross system and cross component issues. This is particularly useful for Global IT companies that manage such global IT landscapes. At 344, the codes or unique identifiers associate a particular issue or problem with a person or group of persons. At 346, the business intelligence tool extracts intelligence from the centralized history of system logs and system traces. In general, the business intelligence tool is software, and in addition to the extraction, the business intelligence tool can analyze the data from the system logs and system traces. The search capabilities of the BI tool leads to faster resolution of IT issues, and the report generating capabilities of the BI tool allows an IT manager to easily view the status of the entire IT landscape.

At 350, in-memory technology is used in connection with the business intelligence tool that executes the examination of the centralized history of system logs and system traces. In general, in-memory technology maintains a database in processor memory rather than on a disk or other storage device. The in-memory technology permits faster processing. At 352, the in-memory technology is configured to maintain the centralized history of the system logs and system traces for a limited period of time, and at 354, the limited period of time comprises approximately three days or less.

At 360, the business intelligence tool executes at least one of a monitoring of the centralized history of system logs and system traces, a root cause analysis, and a provision of support and a solving of the identified issues and problems. A root cause analysis, as its name implies, seeks to identify the origin of a particular problem. If the problem origin can be remedied, then many if not all of the downstream problems caused by the problem origin will be remedied. The provision of support can refer to both personnel support (such as a person to work on and solve the problem) and technological support (such as providing replacement hardware for hardware that is experiencing problems).

At 365, the plurality of system logs and the plurality of system traces originate from at least one of an operating system log and trace, a database log and trace, an application specific log and trace, an infrastructure log and trace, and a peripheral log and trace. At 370, the centralized history of system logs and system traces comprises a format wherein the plurality of system logs and the plurality of system traces are displayable in an adjacent format. At 375, the extraction of data from the plurality of system logs and the plurality of system traces, and the combination of the extracted data into the centralized history of system logs and system traces, comprises a formatting of the data from the plurality of system logs and the plurality of system traces into a unitary format. At 380, a report relating to the identified issues and problems is generated. This report can be automatically transmitted to a particular person(s) or group of persons who have an interest in and/or responsibility for such issues and problems. At 385, the plurality of system logs and system traces are distributed over various portions of an entire end to end information technology landscape. As noted above, the centralized history of system logs and system traces can relate to an entire IT landscape that is covered by different IT vendors. The gathering of the logs and traces into a centralized, uniform format by a BI tool aids in the troubleshooting and analysis of the entire IT landscape.

FIG. 4 is an overview diagram of hardware and an operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks,

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R., §172(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
at least one computer processor and one computer storage device configured to:
maintain in the computer storage device a plurality of system logs and a plurality of system traces;
extract data from the plurality of system logs and system traces;
combine the extracted data into a centralized history of system logs and system traces;
automatically examine the centralized history of system logs and system traces to identify issues and problems in the system;
automatically identify the issues and problems that require attention;
identify a person or a group that is responsible for the identified issues and problems; and
transmit a message to the identified person or group informing the identified person or group of the identified issues and problems.

2. The system of claim 1, wherein the computer processor is configured with a business intelligence tool that executes the examination of the centralized history of system logs and system traces.

3. The system of claim 2, wherein the business intelligence tool identifies issues via codes or unique identifiers that are associated with entries in the centralized history of system logs and system traces.

4. The system of claim 3, wherein the codes or unique identifiers associate a particular issue or problem with a person or group of persons.

5. The system of claim 2, wherein the business intelligence tool extracts intelligence from the centralized history of system logs and system traces.

6. The system of claim 2, wherein at least one of the computer processor and the computer storage device is configured with in-memory technology that is used in connection with the business intelligence tool that executes the examination of the centralized history of system logs and system traces.

7. The system of claim 6, wherein the in-memory technology is configured to maintain the centralized history of the system logs and system traces for a limited period of time.

8. The system of claim 7, wherein the limited period of time comprises approximately three days or less.

9. The system of claim 2, wherein the business intelligence tool is configured to execute at least one of a monitoring of the centralized history of system logs and system traces, a root cause analysis, and a provision of support and a solving of the identified issues and problems.

10. The system of claim 1, wherein the plurality of system logs and the plurality of system traces originate from at least one of an operating system log and trace, a database log and trace, an application specific log and trace, an infrastructure log and trace, and a peripheral log and trace.

11. The system of claim 1, wherein the centralized history of system logs and system traces comprises a format wherein the plurality of system logs and the plurality of system traces are displayable in an adjacent format.

12. The system of claim 1, wherein the computer processor is configured to format the data from the plurality of system logs and the plurality of system traces into a unitary format.

13. The system of claim 1, wherein the computer processor is configured to generate a report relating to the identified issues and problems.

14. The system of claim 1, wherein the computer processor and the computer storage device comprise an entire end to end information technology landscape; and wherein the plurality of system logs and the plurality of system traces are distributed over various portions of the entire end to end information technology landscape.

15. A computer readable storage device comprising instructions that when executed by a processor execute a process comprising:
maintaining in the computer readable storage device a plurality of system logs and a plurality of system traces;
extracting data from the plurality of system logs and system traces;
combining the extracted data into a centralized history of system logs and system traces;
automatically examining the centralized history of system logs and system traces to identify issues and problems in the system;
automatically identifying the issues and problems that require attention;
identifying a person or a group that is responsible for the identified issues and problems; and
transmitting a message to the identified person or group informing e identified person or group of the identified issues and problems.

16. The computer readable storage device of claim 15, comprising instructions for implementing a business intelligence tool that executes the examination of the centralized history of system logs and system traces.

17. The computer readable storage device of claim 16, comprising an in-memory technology that is used in connection with the business intelligence tool that executes the examination of the centralized history of system logs and system traces.

18. The computer readable storage device of claim 16, comprising instructions such that the business intelligence tool is configured to execute at least one of a monitoring of the centralized history of system logs and system traces, a root cause analysis, and a provision of support and a solving of the identified issues and problems.

19. The computer readable storage device of claim 15, wherein the plurality of system logs and the plurality of system traces originate from at least one of an operating system log and trace, a database log and trace, an application specific log and trace, an infrastructure log and trace, and a peripheral log and trace.

20. The computer readable storage device of claim 15, comprising instructions for displaying the plurality of system logs and the plurality of system traces in an adjacent format.

21. The computer readable storage device of claim 15, comprising instructions for formatting the data from the plurality of system logs and the plurality of system traces into a unitary format.

22. The computer readable storage device of claim 15, comprising instructions for generating a report relating to the identified issues and problems.

23. The computer readable storage device of claim 15, wherein the computer readable storage device is part of an entire end to end information technology landscape; and wherein the plurality of system logs and the plurality of system traces are distributed over various portions of the entire end to end information technology landscape.

24. A method comprising:
maintaining in a computer storage device a plurality of system logs and a plurality of system traces;
extracting data from the plurality of system logs and system traces;
combining the extracted data into a centralized history of system logs and system traces;
automatically examining the centralized history of system logs and system traces to identify issues and problems in the system;
automatically identifying the issues and problems that require attention;
identifying a person or a group that is responsible for the identified issues and problems; and
transmitting a message to the identified person or group informing the identified person or group of the identified issues and problems.

25. The method of claim 24, comprising implementing a business intelligence tool that executes the examination of the centralized history of system logs and system traces.

26. The method of claim 25, comprising using an in-memory technology in connection with the business intelligence tool that executes the examination of the centralized history of system logs and system traces.

27. The method of claim 25, comprising executing with the business intelligence tool at least one of a monitoring of the centralized history of system logs and system traces, a root cause analysis, and a provision of support and a solving of the identified issues and problems.

28. The method of claim 24, wherein the plurality of system logs and the plurality of system traces originate from at least one of an operating system log and trace, a database log and trace, an application specific log and trace, an infrastructure log and trace, and a peripheral log and trace.

29. The method of claim 24, comprising displaying the plurality of system logs and the plurality of system traces in an adjacent format.

30. The method of claim 24, comprising formatting the data from the plurality of system logs and the plurality of system traces into a unitary format.

31. The method of claim 24, comprising generating a report relating to the identified issues and problems.

32. The method of claim 24, wherein the computer storage device is part of an entire end to end information technology landscape; and wherein the plurality of system logs and the plurality of system traces are distributed over various portions of the entire end to end information technology landscape.
